(19) United States
(12) Patent Application Publication
(10) Pub. No.: US 2013/0013370 A1
(43) Pub. Date: Jan. 10, 2013

(54) SYSTEM AND METHOD FOR AUTOMATICALLY GENERATING AN OPTIMIZED BUSINESS PROCESS DESIGN

(75) Inventors: Shivi Mithal, Bangalore (IN); Bijoy Majumdar, Sec'bad (IN); Manivannan Gopalan, Trichy (IN); Apeksha Apeksha, Bihar (IN)

(73) Assignee: INFOSYS LIMITED, Bangalore (IN)

(21) Appl. No.: 13/619,038

(22) Filed: Sep. 14, 2012

Related U.S. Application Data
(63) Continuation-in-part of application No. 12/317,932, filed on Dec. 30, 2008.

(30) Foreign Application Priority Data
Sep. 14, 2011 (IN) 3152/CHE/2011

(51) Int. Cl. G06Q 10/06

(52) U.S. Cl. 705/7.27; 705/7.39

(57) ABSTRACT

A design module for automatically optimizing business processes in an organization. Each business process to be optimized is characterized by one or more performance indicators. One or more process characteristics are identified corresponding to each of the performance indicators. For each of the process characteristics, at least one transformation pattern is identified. Thereafter, one or more transformation patterns are selected from the identified transformation patterns, for optimizing the process characteristics, and thereby optimizing the business processes. The design module generates workflow patterns based on the identified transformation patterns and converts them into BPEL constructs for visually displaying the workflow patterns on a user interface.

### RELATED APPLICATIONS

The present application claims the benefit of priority under 35 U.S.C. 119 to Indian Patent Application Serial No. 3152/CHE/2011, filed Sep. 14, 2011 in the name of inventors Shivi Mithal, Bijoy Majumdar, Manivannan Gopalan, and Apeksha Apeksha and entitled, “System and Method for Automatically Generating an Optimized Business Process Design,” commonly owned herewith.

The present application is also a continuation-in-part of co-pending U.S. patent application Ser. No. 12/317,932 filed Dec. 30, 2008, in the name of inventors Amit Agrahari, Shivi Mithal, and Jyoti Bhat and entitled, “Pattern Based Process Optimizer,” which claims the benefit of priority under 35 U.S.C. 119 to Indian Patent Application Serial No. 2668/CHE/2008, filed Nov. 3, 2008, all commonly owned herewith.

### FIELD

The present disclosure relates to a system and method for automatically generating an optimized business process design.

### BACKGROUND

An organization employs a variety of processes at different stages of its operations. The organization is constantly looking for ways to improve its operations. There are multiple ways to enhance the functions of the organization such as improving the efficiency of existing business processes by redesigning existing business processes or introducing new business processes.

Typically, any innovation in a business process is preceded by a thorough study of the process characteristics associated with the process. In an aspect, a process characteristic refers to the property of a business process that is affected or altered by the outcome of the business process redesign. Examples of process characteristics include cost, time, quality, and the like. Improvements in the business processes are aimed at altering the process characteristics in order to reach a desired output. For example, process improvements may be aimed at reducing processing time and associated costs. Generally, process improvements are implemented to address issue(s), problems(s), or improvement opportunities associated with the process.

Conventionally, improvements in processes are suggested by consultants with the help of various tools. However, the tools currently used only have data capturing and simulation capabilities, and they do not provide recommendations regarding the alterations that should be made in the process. Further, simulation can only help for a limited set of process characteristics, such as time and cost, and cannot help in improving other process characteristics that may impact a process' efficiency, such as flexibility, reliability, and so forth.

Irrespective of the kind of methodology, the design of future state process or simply redesign of a process has always remained a brainstorming activity. There are standard ways to capture processes, to analyze and identify the root cause but actual redesign of process has continued to be a manual activity.

Process redesigning being carried out as an entirely manual activity has quite a few disadvantages. Firstly, the quality of redesigned process becomes dependent on the capabilities of the business analyst. Secondly, lack of proper methods to think of a solution makes it extremely difficult to train young consultants to redesign processes. Lastly, any large scale process improvement is a time consuming operation.

Additionally, there is currently no means for automatically suggesting a redesigned process that is based on proposed transformation patterns.

What is needed is a method, system and computer program product for efficiently optimizing business processes in the organization based on available information. What is also needed is a means for automatically suggesting a redesigned process that is visually presentable to the user.

### SUMMARY

In an aspect, a method for optimizing one or more business processes in an organization is disclosed. The method comprises selecting, using one or more processors, at least one business process to be optimized. The method comprises identifying, using one or more processors, a first performance indicator associated with the selected business process. The method comprises identifying, using one or more processors, a first process characteristics corresponding to at least the first performance indicator. The method comprises determining, using one or more processors, at least one transformation pattern corresponding to the first process characteristics, wherein the at least one transformation pattern is identified based on at least one predefined criteria.

In an aspect, a non-transitory machine readable medium is disclosed. The medium, having stored thereon, instructions for optimizing one or more business processes in an organization. The instructions comprising machine executable code which when executed by at least one machine, causes the machine to select at least one business process to be optimized. The machine is caused to identify a first performance indicator associated with the selected business process. The machine is caused to identify a first process characteristics corresponding to at least the first performance indicator. The machine is caused to determine at least one transformation pattern corresponding to the first process characteristics, wherein the at least one transformation pattern is identified based on at least one predefined criteria.

In an aspect, a computer system comprises a network interface configured to allow communications between the computing system and one or more network devices, a memory and a processor. The processor is coupled to the network interface and the memory and is operative to select at least one business process to be optimized. The processor is operative to identify a first performance indicator associated with the selected business process. The processor is operative to identify a first process characteristics corresponding to at least the first performance indicator. The processor is operative to determine at least one transformation pattern corresponding to the first process characteristics, wherein the at least one transformation pattern is identified based on at least one predefined criteria.

In one or more of the above aspects, the system and method is configured to select a first transformation pattern for optimizing the one or more process characteristics. The system and method is configured to analyze the first transformation pattern and retrieve one or more workflow patterns associated with the first transformation pattern from a database. The system and method is configured to map the one or more workflow patterns to a corresponding one or more executable programming commands. The system and method is configured to execute the programming commands to display the workflow patterns in a user interface.

In one or more of the above aspects, the system and method is configured to identify a point of applicability of the selected transformation patterns in the one or more business processes, wherein the selected transformation patterns are applied in the business process at a point of applicability. The system and method configured to identify a first improvement opportunity associated with the business process.

In one or more of the above aspects, the system and method is configured to identify the first one or more performance indicators and the first improvement opportunities comprises defining the one or more performance indicators of the business process, wherein the one or more performance indicators are defined by a user.

In one or more of the above aspects, the system and method is configured to associate at least one of an improvement opportunity and a performance indicator with at least one process characteristic. In one or more aspects, the predefined set of process characteristics and the set of predefined transformation patterns are stored in a transformation pattern database. In one or more aspects, at least one predefined criterion is based on impact of the at least one transformation pattern on the corresponding process characteristics wherein the at least one predefined criterion is and stored in the transformation pattern database.

In one or more of the above aspects, the system and method is configured to analyze a set of data points corresponding to the business process, wherein the set of data points is used for checking the applicability of the identified transformation patterns.

### BRIEF DESCRIPTION OF THE DRAWINGS

FIG. 1 illustrates an example system including a network device implementing a design module in accordance with an aspect of the present disclosure;

FIG. 2A illustrates a block diagram of a network device in accordance with an aspect of the present disclosure;

FIG. 2B illustrates a block diagram of the design module in accordance with an aspect of the present disclosure;

FIG. 3 illustrates a flowchart of a method for optimizing a business process in an organization in accordance with an aspect of the present disclosure;

FIG. 4 illustrates a flowchart of a method for identifying transformation patterns corresponding to process characteristics in accordance with an aspect of the present disclosure;

FIGS. 5A-5B illustrate flowcharts of a method for selecting transformation patterns for optimizing the process characteristics in accordance with an aspect of the present disclosure; and

FIG. 6 illustrates a flowchart of a method of generating and displaying proposed workflow patterns in accordance with an aspect of the present disclosure.

### DETAILED DESCRIPTION

The present disclosure is directed to a method, system and computer program product for automatically optimizing business processes in an organization. In particular, system and method utilizes a design module which analyzes the performance of each business process to be optimized by measuring one or more performance indicators, each of which corresponds to one or more process characteristics. One or more transformation patterns are selected by the design module to optimize the process characteristics and thereby optimize the business processes. The design module also analyzes the proposed transformation patterns and automatically selects workflow patterns associated the proposed transformation patterns and converts the selected workflow patterns into a form to be visually displayed on a user interface. The selected workflow patterns allow the user to visually identify the optimized business processes.

The present system and method has several advantages. The method provides a practitioner or a consultant with an efficient method for optimizing and redesigning business processes. Further, the business processes can be redesigned by using the available information since the method does not impose any rigid information requirement. Furthermore, the present disclosure provides a system and method for process redesign that is easy to understand and simple to implement. Moreover, the system and method of the present disclosure brings structure into the art of process redesign.

Typically, an organization employs various business processes, hereinafter interchangeably referred to as processes, in various departments and at various stages of its function. These processes are optimized or redesigned in order to improve the functions of the organization and/or to resolve the issues in the business processes. Performance indicators, also referred to as process performance indicators or key performance indicators, refer to the parameters or metrics that are used to define or measure the performance of a business process. A process characteristic refers to the property of the business process that is affected or altered by the outcome of the business process redesign. In other words, process characteristics are the fundamental attributes of the process.

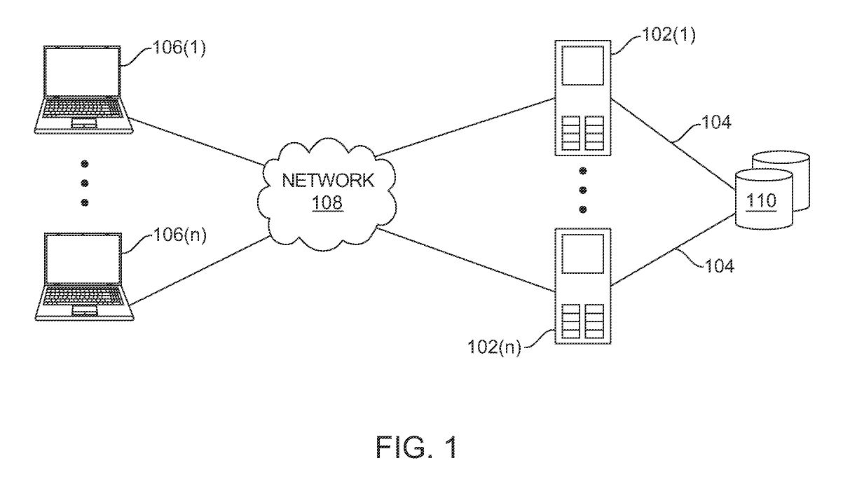

FIG. 1 illustrates a diagram of an example system environment that implements and executes a business process optimization system and method in accordance with an aspect of the present disclosure. In particular, the example system environment 100 includes a plurality of network devices. It should be noted that the term “network devices” can be referred to as encompassing one or more client devices, one or more physical and/or virtual servers, cloud computing devices and/or other components in the system 100.

The servers 102(1)-102(n) including but not limited to application servers, database servers, computation farms, data centers, virtual machines, cloud computing devices, mail or web servers and the like. The network system 100 includes one or more client devices 106(1)-106(n), although the environment 100 could include other numbers and types of devices in other arrangements.

The servers 102(1)-102(n) are connected to a local area network (LAN) 104 and the client devices 106(1)-106(n) are connected to a wide area network 108. The servers 102(1)-102(n) comprise one or more network devices or machines capable of operating one or more Web-based and/or non Web-based applications that may be accessed by other network devices (e.g. client devices, other servers) via the network 108. One or more servers 102(1)-102(n) may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources.

One or more servers 102 may comprise a cluster of a plurality of servers which are managed by a network traffic device such as a firewall, load balancer, web accelerator, gateway device, router, hub and the like. In an aspect, one or more servers 102(1)-102(n) may implement a version of Microsoft® IIS servers, RADIUS servers and/or Apache® servers, although other types of servers may be used and other types of applications may be available the on servers 102(1)-102(n). It should be noted that although the client device, network management system, and/or server may be referred to herein in the plural, it is contemplated that only one client device, one network management system, and/or one server may be considered without being limiting to the language used herein. It should be understood that the particular configuration of the system 100 shown in FIG. 1 are provided for exemplary purposes only and is thus not limiting.

Client devices 106(1)-106(n) comprise network computing devices capable of connecting to other computing devices, such as the servers 102(1)-102(n). Such connections are performed over wired and/or wireless networks, such as network 108, to send and receive data, such as Web-based and/or non Web-based requests, receiving responses to requests and/or performing other tasks, in accordance with the novel processes described herein. Non-limiting and non-exhausting examples of such client devices 106(1)-106(n) include, but are not limited to, personal computers, mobile phones and/or smart phones, pagers, tablet devices, PDAs and the like.

In an aspect, a client device may be configured to run a Web browser or other software module that provides a user interface for human users to interact with and access the design module 210. For example, the client device may include a locally stored mobile application which allows the user to request resources and/or information via the mobile application.

Network 108 comprises a publicly accessible network, such as the Internet, which handles communication between the client devices 106(1)-106(n) and the servers 102(1)-102(n) of the IT infrastructure 102′. However, it is contemplated that the network 108 may comprise other types of private and/or public networks. Communications between the client devices 106(1)-106(n) and the servers 102(1)-102(n) preferably take place over the network 108 according to network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications technologies.

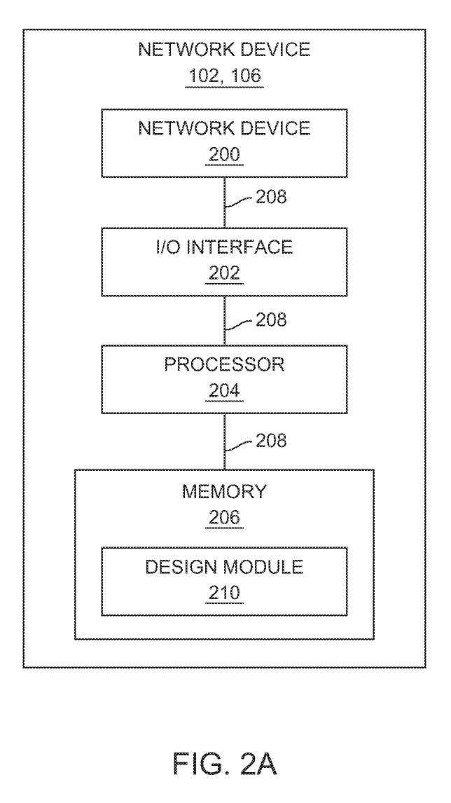

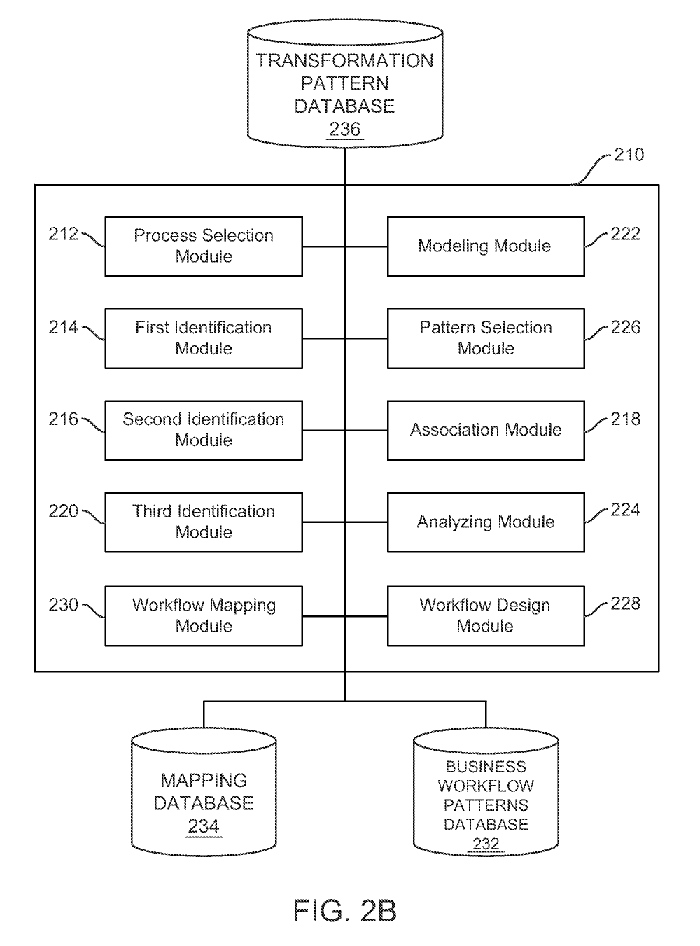

FIG. 2A illustrates a block diagram of a network device in accordance with an aspect of the present disclosure. With regard to FIG. 2A, the network device may be one or more of a plurality of servers 102 and/or one or more client device 106. The network device 102, 106 includes one or more device processors 200, one or more device I/O interfaces 202, one or more network interfaces 204 and one or more device memories 206, all of which are coupled together by one or more buses 208. It should be noted that the network device 102 could include other types and numbers of components.

Device processor 200 comprises one or more microprocessors configured to execute computer/machine readable and executable instructions stored in the respective local or remote device memory 206. Such instructions are implemented by the processor 200 to perform one or more functions described below. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200 is programmed or configured to execute the process in accordance with the teachings as described and illustrated herein of the novel system and method described below.

Device I/O interfaces 202 comprise one or more user input and output device interface mechanisms. The interface may include a computer keyboard, mobile device keypad, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204 comprises one or more mechanisms that enable the client devices 106 and/or the servers 102 to engage in TCP/IP communications or other communications over the LAN 104 and network 108. However, it is contemplated that the network interface 204 may be constructed for use with other communication protocols and types of networks. Network interface 204 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200 (or a processor 200 has more than one core), each processor 200 (and/or core) may use the same single network interface 204 or a plurality of network interfaces 204 to communicate with other network devices. Further, the network interface 204 may include one or more physical ports, such as Ethernet ports, to couple its respective device with other network devices in the system 100. Moreover, the network interface 204 may include certain physical ports dedicated to receiving and/or transmitting certain types of network data, such as device management related data for configuring the respective device, and the like.

Bus 208 may comprise one or more internal device component communication buses, links, bridges and supporting components, such as bus controllers and/or arbiters. The bus enable the various components of the network device such as the processor 200, device I/O interfaces 202, network interface 204, and device memory 206, to communicate with one another. However, it is contemplated that the bus may enable one or more components of its respective network device to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the network device which houses the bus.

Device memory 206 of the network device comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200. As shown in FIG. 2A, the design module 210 is shown within the memory 206 and comprises computer readable/machine executable instructions. It is contemplated that the design module 210 may alternatively be housed in a memory external to the memory 206.

Such stored instructions allow the processor 200 to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed

FIG. 2B illustrates a block diagram of the design module configured to optimize a business process in an organization in accordance with an aspect of the present disclosure. The design module enables one or more users to optimize and/or redesign one or more business processes in an organization to improve the functions of the organization and/or to resolve the issues or problems in the organization's business process. The design module also analyzes the proposed transformation patterns and automatically selects workflow patterns associated the proposed transformation patterns and converts the selected workflow patterns into a form to be visually displayed on a user interface.

The design module 210 includes a process selection module 212, a first identification module 214, a second identification module 216, an association module 218, a third identification module 220, a modeling module 222, an analyzing module 224, a pattern selection module 226, a workflow design module 228 and a workflow mapping module 230. The design module 210 is configured to access one or more databases such as the business workflow pattern database 232, the mapping database 234 and the transformation pattern database 236. It should be noted that the described modules and database are exemplary and that the optimization module 212 may comprise additional and/or other modules to perform the novel process of the present disclosure.

The process selection module 212 is configured to allow the user, via a user interface, to select or identify a business process to be optimized. Relevant information needed to optimize the business process can be provided by the user or can be selected from one or more stored files in a database. For example, an organization, such as a software services company, the user can provide information to the process selection module 212 that describes the different processes of a new project initiation process, billing of a project or project invoice generation, and so forth. In an exemplary scenario, when both the processes mentioned above need to be optimized, then each process is selected separately by the optimization module 210.

The first identification module 214 is configured to identify at least one of a plurality of performance indicators and/or improvement opportunities (described below) associated with the business process(es) being optimized. In an aspect, the first identification module 214 allows the user to identify and/or define, via the user interface, one or more performance indicators on the basis of the organization's business requirements. In an aspect, design module 210 stores identified and/or defined performance indicator information in one or more storage databases, whereby the performance indicator information can easily be accessed, utilized and/or modified by the design module 210. The performance indicators are displayed by the first identification module 212 in a reference list in the user interface.

The second identification module 216 is configured to identify one or more process characteristics that are identified from a predefined set of process characteristics. As described, process characteristics include, but is not limited to, cost, time, flexibility, reliability, throughput, effectiveness, quality, control and the like. Additionally, the second identification module 216 is configured to identify the impact of the process characteristics on the performance indicators.

The association module 218 is configured to associate the identified performance indicators with the identified process characteristics. In an aspect, the association module 218 is configured to identify one or more process characteristics that are considered as constraints. In an aspect, the association of the performance indicators and/or the improvement opportunities with the process characteristics is predefined and can be modified by a user, consultant and/or a practitioner. The associations defined or modified by the user during the execution of different processes are stored by the design module 210 and can be used as predefined associations for use in the future. Regarding the software services company example, if the process being analyzed is a project invoice generation process, the issue of the time taken to finalize the invoice relates to the process characteristic ‘cycle time’. Additional to the example, the issue of miscommunication between the project managers and the finance department can be associated to the process characteristic ‘quality’.

The third identification module 220 is configured to identify at least one transformation pattern which corresponds to the selected process characteristics. The transformation pattern is identified by the user and/or module 220 from a predefined set of transformation patterns that are for consideration. The transformation patterns are identified on the basis of at least one predefined criteria. As stated above, the predefined criterion may include a predefined relation or impact between the transformation pattern and the process characteristic (e.g. positive impact, negative impact such as a constraint).

The transformation pattern database 236 comprises one or more databases configured for storing the predefined set of process characteristics and the predefined set of transformation patterns as well as information regarding the impact of the transformation pattern on the process characteristic.

The analyzing module 224 is configured to analyze a set of data points which correspond to the business process being considered. In particular, the data points are used for checking the applicability of the transformation patterns identified by third identification module 220 by using one or more applicability algorithms. In an aspect, the data points can be stored as well as retrieved from the transformation pattern database 236.

The pattern selection module 226 is configured to select one or more transformation patterns identified by the third identification module 226. In an aspect, the transformation patterns are selected by the pattern selection module 416 based on the applicability of the identified transformation patterns which are determined by the design module 210 to optimize the process characteristics as well as satisfy the constraints. The pattern selection module 226 is further configured to identify and apply one or more points of applicability of the selected transformation patterns at the one or more points of applicability. In an aspect, the results of the applied transformation patterns are checked by the design module 210 by comparing the outcomes of the optimized business process and the original business process in terms of the improvement opportunities and/or the performance indicators.

As shown in FIG. 2B, the workflow design module 228 is configured to access one or more business-workflow pattern databases 232 to retrieve one or more workflow patterns which are applicable to the transformation pattern(s) being considered. Additionally, the workflow mapping module 230 is configured to access one or more mapping databases 234 to retrieve executable commands that correspond to convertible BPEL constructs that are representative of the workflow patterns. The BPEL constructs representative of the workflow patterns are processed by the modeling module 222, which converts the workflow patterns into visual form to allow the user to view the suggested workflow pattern on a user interface.

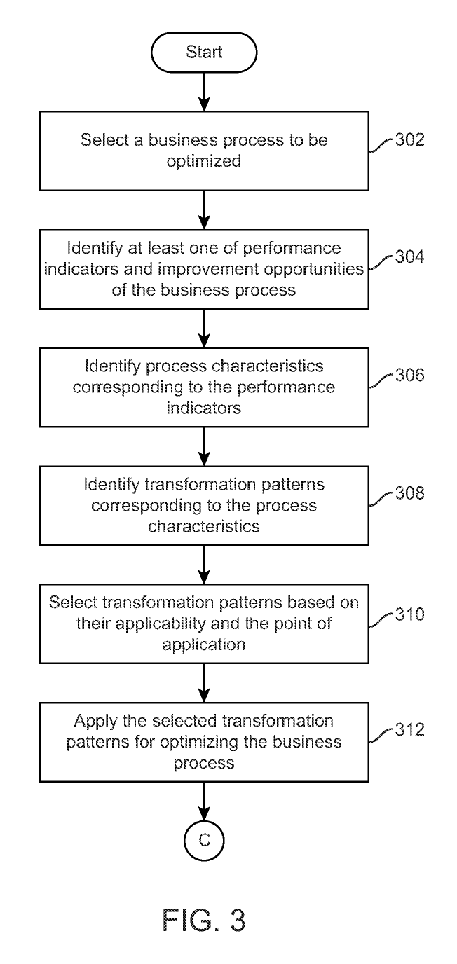

FIG. 3 illustrates a flowchart of a method for optimizing business processes in an organization in accordance with an aspect of the present disclosure. It should be noted that the steps shown in FIG. 3 are exemplary to described process and may include additional/different steps.

At step 302, a business process to be optimized is selected. The business process is selected from the various business processes in the organization that need to be optimized or redesigned. For example, an organization, such as a bank, employs different processes such as savings account opening process, check clearance process, and so forth. In an exemplary scenario, when both the processes mentioned above need to be optimized, each process is selected separately.

At step 304, at least one of one or more performance indicators and one or more improvement opportunities is identified. The performance indicators and the improvement opportunities correspond to the business process. Therefore, either of the two or both are identified corresponding to the business process. For example, the performance indicators for the savings account opening process can be related to the number of calls received by a call center per account opened, the number of lost mails corresponding to opening of account, and so forth. In an embodiment of the invention, the performance indicators are identified by a business user or the people who own or run the business, based on the business requirements of the organization.

In another example, if a computer manufacturing organization needs to increase its profitability by improving its customizability, then the performance indicators for the organization will include collecting customer requirements properly. On the other hand, if the organization needs to capture the market by introducing low-cost products, then ‘cost’ will be the performance indicator for the organization. The performance indicators are identified using a reference list containing predefined performance indicators. In another embodiment of the invention, the performance indicators for a process are defined by a business user, based on the business requirements of the organization. In other words, rather than identifying or selecting the performance indicators from the reference list, a business user defines the performance indicators by inserting them into a fillable field in a displayed user interface.

For example, in a bank, the following can be the different improvement opportunities, also referred to as issues, associated with the savings account opening process:

1. After submitting account opening forms, customers receive documents related to the bank account after some delay. However, they expect the account to be operational in a short period of time.

2. Significant number of calls received by the bank's call centers because of the delay in the delivery of one or more documents related to the bank account.

3. Cost of resending delayed or lost documents.

4. Customers are dissatisfied due to non-receipt of the documents related to the bank account.

5. Significant cost of stationery.

In an aspect, the improvement opportunities are identified by a user. It will be apparent to a person skilled in the art that the improvement opportunities are identified by a business user on the basis of the business requirements of the organization.

At step 306, one or more process characteristics are identified. The process characteristics are identified by the system from a predefined set of process characteristics which includes, but is not limited to, cost, time, flexibility, reliability, throughput, effectiveness, quality, and control. In an aspect, the predefined set of process characteristics is stored in the transformation pattern database 236. Each process characteristic corresponds to one or more performance indicators of the business process and vice versa.

In an exemplary scenario, the relationship between process characteristics and performance indicators can be defined in the following way: process characteristic X increases with performance indicator P and decreases with performance indicator Q; process characteristic Y decreases with both performance indicator Q and performance indicator R; and so forth.

In an aspect, the performance indicators are associated with at least one of the process characteristics included in the predefined set. The association between the performance indicators and the process characteristics is predefined in the system in an aspect. However, the predefined associations between the process characteristics and the performance indicators can be modified or altered by a consultant or a practitioner on the basis of the improvements or changes required in the business process. In another aspect, the association between the user-defined performance indicators and the process characteristics is defined by the user, a consultant or a practitioner.

In an aspect, the impact of the process characteristics on the performance indicators is identified. The association between the performance indicators and the process characteristics helps in determining this impact. For example, in the above described savings account opening process, the performance indicator that is identified is the number of calls made per account to a call center. Further, if it is ascertained that the majority of the calls are because of the delay in the delivery of documents related to the opening of the bank account, then the process characteristic ‘time’ needs to be decreased to improve the business process. On the contrary, if it is ascertained that customer requests are not being addressed and the customers are calling repeatedly, then the process characteristic ‘reliability’ needs to be increased.

At step 306, the improvement opportunities are associated with the process characteristics. For example, of the five improvement opportunities or issues identified for the example savings account opening process, the issue of delay in receiving documents by a customer relates to the process characteristic ‘cycle time’. The number of calls made to call centers, the cost of resending documents to the customers, and dissatisfaction of the customers due to non-receipt of the documents are the result of a process which fails or breaks down during execution. That is, the issues in the present example relate to reliability whereas the issue of cost of stationery relates to cost.

In an aspect, the association of the performance indicators and/or the improvement opportunities with the process characteristics is defined by using process maps as inputs. A process map describes a business process in terms of the activities involved in the business process and the people involved in performing the activities. In an aspect, the process maps are diagrammatically represented in the form of flowcharts.

Based on the significance of the process characteristics in achieving the business goal of the organization, some process characteristics are characterized as constraints, as may be performed in step 306. Constraints are the restrictions on the business process and refer to the process characteristics that should not change. In other words, a process characteristic is identified as a constraint if it remains unaffected in the optimized or redesigned business process.

For example, the issue of significant cost of stationery related to the example savings account opening process, stated in reference to step 104, is a relatively less significant issue for the bank as compared to the other issues. Therefore, the corresponding process characteristic ‘cost’ is identified as a constraint. In other words, although the optimized business process may not reduce the process characteristic corresponding to this issue, the optimized business process should also not increase the process characteristic ‘cost’.

At step 308, at least one transformation pattern corresponding to the process characteristics is identified. Transformation patterns are abstractions of the changes that can be performed in a process. In an aspect, the transformation pattern is identified from a predefined set of transformation patterns including, but not limited to, ‘Control Relocation’, ‘Contact Reduction’, ‘Integration’, ‘Task Elimination’, ‘Triage’, ‘Task Composition’, ‘Re-sequencing’, ‘Exception’, ‘Split Responsibilities’, ‘Extra Resources’, ‘Buffering’, ‘Task Automation’, ‘Outsourcing’, and ‘Interfacing’. Each transformation pattern in the predefined set of transformation patterns corresponds to at least one of the process characteristics and vice versa.

In an aspect, the predefined set of transformation patterns is stored in a transformation pattern database 236. In an aspect, the predefined relation between the transformation pattern and the process characteristic includes the impact of the transformation pattern on the process characteristic. A transformation pattern can have a positive, negative or neutral impact on a process characteristic.

In an example, it is desired to increase process characteristic X in a particular business process. If it is determined that process characteristic X increases when a transformation pattern P is applied, then transformation pattern P has a positive impact on process characteristic X. On the contrary, if process characteristic X decreases, this implies that transformation pattern P has a negative impact on process characteristic X.

The predefined relation also includes the impact of the transformation pattern on the process characteristics identified as constraints. For example, in the savings account opening process having cycle time and reliability as process characteristics, and cost as a constraint, the transformation patterns identified from the predefined set of transformation patterns include ‘Control Relocation’, ‘Contact Reduction’, ‘Integration’, ‘Task Elimination’, ‘Order-based Work’, ‘Triage’, ‘Task Composition’, ‘Re-sequencing’, ‘Exception’, ‘Order Assignment’, ‘Flexible Assignment’, ‘Centralization’, ‘Case Manager’, ‘Extra Resources’, ‘Specialist-Generalist’, ‘Buffering’, ‘Task Automation’, ‘Integral Business Process Technology’, ‘Trusted Party’, and ‘Interfacing’.

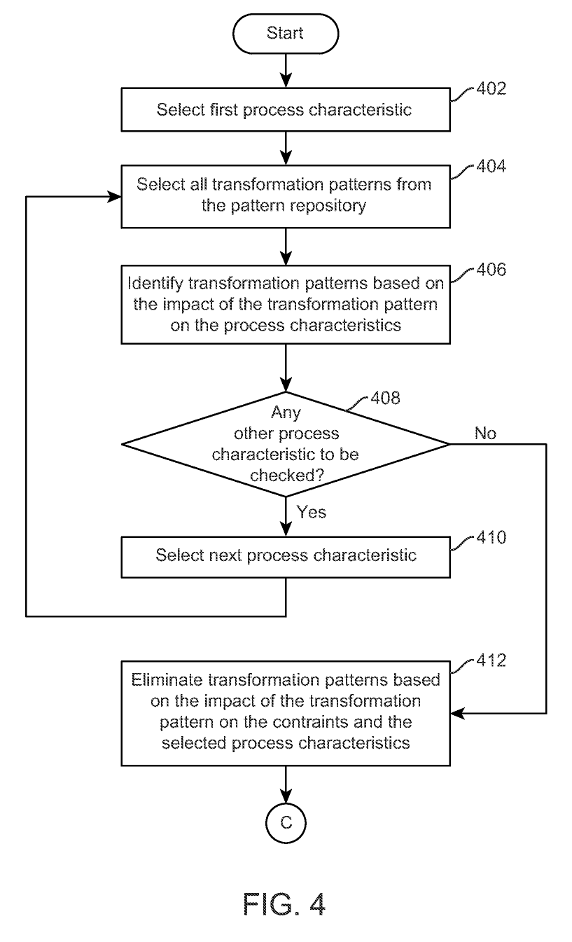

The transformation patterns identified above may have a positive impact on at least one of the two process characteristics, cycle time and reliability, in an aspect. That is, each of the transformation patterns either reduces the cycle time and/or improves the reliability of the process. The identification of the transformation patterns corresponding to the process characteristics has been explained in detail in conjunction with FIG. 4.

In an aspect, the predefined criterion for identifying the transformation patterns is stored in a transformation pattern database 236. In an embodiment of the invention, the impact of the transformation pattern on the process characteristic is stored in the following format:

TABLE 1
Relation between a transformation pattern
and its impact on process characteristics

| | | Positive | Negative |
|---|---|---|---|
| Pattern Name | Description | Impact | Impact |
| Split | Shared responsibility | Time | |
| Responsibilities | between two departments | Quality | |
| | is often a cause of | | |
| | neglect, conflict and | | |
| | hence delays. This best | | |
| | practice identifies this | | |
| | fact and suggests to | | |
| | reduce overlap in | | |
| | responsibilities to avoid | | |
| | these problems. | | |

As shown above, Table 1 includes the name of the transformation pattern, its description, the process characteristic(s) on which it has a positive impact and the process characteristic(s) on which it has a negative impact. If a process characteristic is not mentioned with a transformation pattern, it means that the transformation pattern has a neutral impact on that process characteristic.

At step 310, one or more transformation patterns are selected from the transformation patterns identified at step 308. The transformation patterns are subjected to a test of applicability in order to select transformation patterns from the transformation patterns identified at step 308.

For example, in the example savings account opening process, based on the 20 identified transformation patterns stated in reference to step 108, 11 transformation patterns are selected: ‘Contact Reduction’, ‘Order-based Work’, ‘Triage’, ‘Re-sequencing’, ‘Order Assignment’, ‘Centralization’, ‘Buffering’, ‘Task Automation’, ‘Integral Business Process Technology’, ‘Trusted Party’, and ‘Interfacing’. Since every transformation pattern is not applicable to every business situation, transformation patterns are selected or shortlisted on the basis of their applicability in the business process.

The applicability of the identified transformation patterns is checked by using a set of data points corresponding to the business process. Data points refer to the information corresponding to the business process that is used to check the applicability of the transformation patterns. For example, data points such as, mean time to execute the process, standard deviation of the time to execute the process, the number of cases where standard deviation is ‘High’, and the like, are used to check the applicability of the transformation pattern ‘Exception’.

In an aspect, the data points that correspond to the business process are analyzed and then used to check which transformation patterns are applicable. The system then selects one or more transformation patterns from the identified transformation patterns.

Furthermore, the transformation pattern ‘Task Composition’ is rejected since the set-up time required for each step is less, as compared to the overall process time. In an embodiment of the invention, the data points are stored in the transformation pattern database 236.

In an embodiment of the invention, analyzing the set of data points includes applying one or more applicability algorithms to check the applicability of the identified transformation patterns. The applicability algorithms include one or more mathematical formulae that utilize the data points to check the applicability of the identified transformation patterns. For example, the following applicability algorithm is used to check the applicability of the transformation pattern ‘Exception’:

If Standard Deviation=‘High’ AND Number of cases where standard deviation is ‘High’>30% THEN Apply pattern ‘Exception’

The transformation patterns are selected from the identified transformation patterns to optimize the process characteristics. The transformation patterns that satisfy the constraints are also selected. For instance, in the example savings account opening process, the 11 selected transformation patterns are used to optimize the process characteristics. The optimization of the process characteristics resolves the improvement opportunities, improves the performance indicators and satisfies the constraints. The optimization of the process characteristics thereby optimizes the corresponding business process.

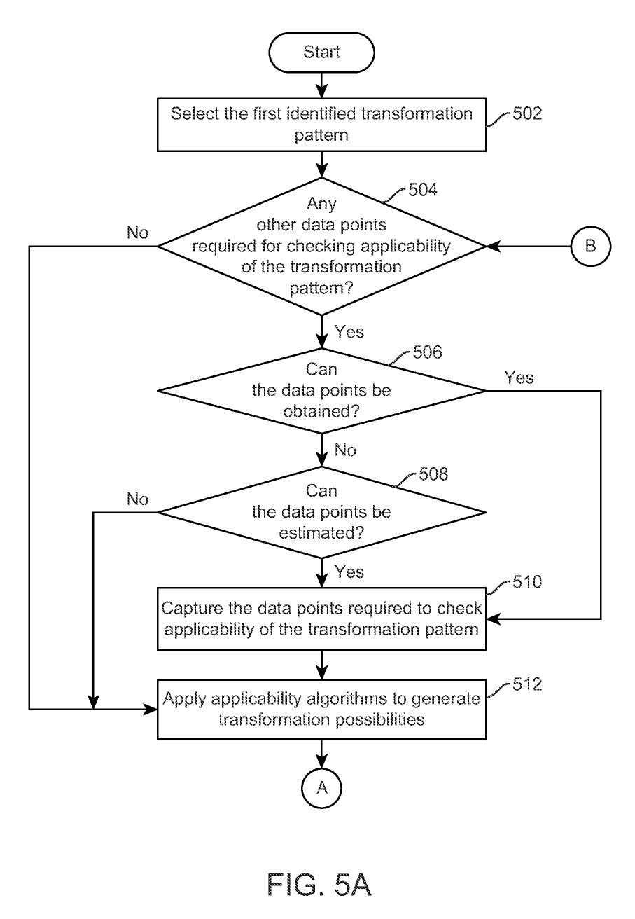

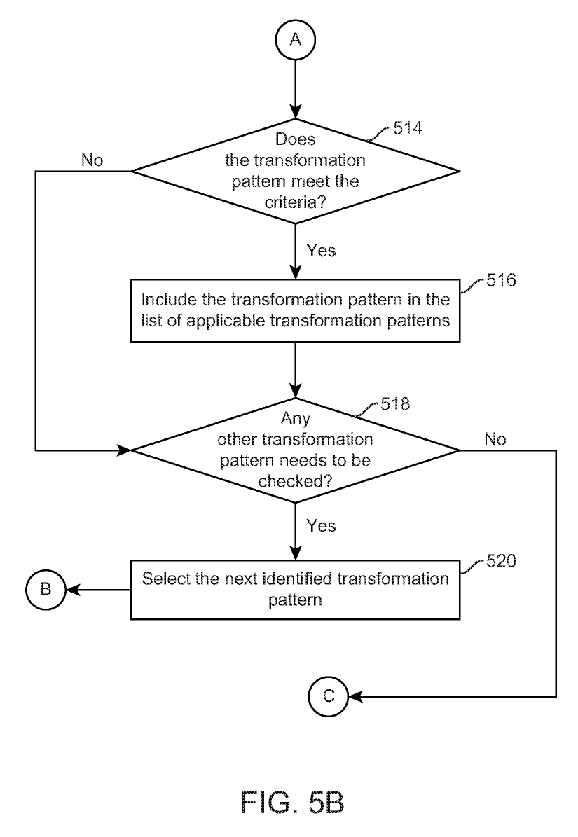

At step 310, one or more points of applicability of the selected transformation patterns are identified. The selected transformation patterns are applied in the business process at the one or more points of applicability. For instance, in the example savings account opening process, the transformation pattern ‘Triage’ is applied at the point of delivery of documents related to opening a bank account. The selection of the transformation patterns to optimize the process characteristics has been explained in detail in conjunction with FIGS. 4 and 5.

At step 312, the transformation patterns selected at step 310 are applied to optimize the business process, whereby the process continues to Block C. The selected transformation patterns are analyzed by a consultant or a practitioner, along with the business user(s), to verify the applicability of the selected transformation patterns depending on the business situation. Based on the practical applicability, the selected transformation patterns are applied to the business process at their respective points of applicability to resolve the issues or improvement opportunities associated with the business process and thus, optimize the business process.

For instance, in the example savings account opening process, the following 7 transformation patterns are selected from the 11 selected transformation patterns stated in reference to step 310: ‘Order-based Work’, ‘Triage’, ‘Re-sequencing’, ‘Centralization’, ‘Task Automation’, ‘Contact Reduction’, and ‘Integral Business Process Technology’. These 7 transformation patterns are selected on the basis of their practical applicability to the business process and are used by the bank to optimize the process characteristics (and business process).

In an aspect, the resolution obtained is stored in a transformation pattern database 236 in the following format along with the corresponding transformation pattern's name and the data points, that is, the information required to check the applicability of the transformation pattern, as shown in Table 2.

TABLE 2
Suggested resolution for a transformation pattern

| Pattern Name | Information | Resolution |
|---|---|---|
| Split | Information Need | The resolution is to |
| Responsibilities | 1. No. of departments in | involve the person |
| | process | having the functional |
| | 2. No. of reconciliation | knowledge in the team |
| | activities | where the transaction |
| | 3. No. of co-ordination | data is generated. |
| | activities | Example, a HR or a |
| | 4. Mean time taken to | Finance person can |
| | complete the process | join the production |
| | and its standard | team, or a product |
| | deviation | development person can |
| | | join the CRM team. |

In an aspect, simulations are used to check the result of the application of the selected transformation patterns. This is done, in an aspect, by comparing the outcomes of the optimized business process and the original business process in terms of the performance indicators, the improvement opportunities and the impact of the improvement opportunities on the process characteristics. For instance, in the example savings account opening process, it may be determined that the cycle time was reduced from a period of 2 or 3 weeks down to a period of three days. It may also be determined that the number of calls received by the call center also reduced significantly as a result of applying the selected transformation patterns, such as ‘Re-sequencing’, ‘Contact Reduction’, and the like.

In an aspect, an organization, such as a bank, employs different business processes, such as savings account opening, cheque clearance, and the like. The business process, such as savings account opening process, needs to be optimized and is therefore selected. Thereafter, the improvement opportunities or issues associated with the process are identified, wherein examples include, but are not limited to, the delay in delivery of documents related to the bank account, the number or volume of calls received by the bank's call center due to the delay, the cost of resending the lost documents, customer dissatisfaction due to non-receipt of documents, the cost of stationery, and the like.

Process characteristics such as cost, cycle time and reliability, are identified for the corresponding improvement opportunities. For the above example, the delay in delivery of documents relates to the process characteristic ‘cycle time’, and the issue of cost of stationery relates to the process characteristic ‘cost’. Similarly, issues that are related to the process characteristic ‘reliability’ include the number of calls made to the bank's call center due to the delay in delivery of account-related documents to the customers, the cost of resending the lost documents, and customer dissatisfaction due to non-receipt of the documents. Since the issue related to the cost of stationery is relatively less significant for the bank as compared to the other issues, the process characteristic ‘cost’ is identified as a constraint.

The following 20 transformation patterns corresponding to cycle time and reliability as process characteristics and cost as a constraint are then identified from the predefined set of transformation patterns that have a positive impact on the process characteristics: ‘Control Relocation’, ‘Contact Reduction’, ‘Integration’, ‘Task Elimination’, ‘Order-based Work’, ‘Triage’, ‘Task Composition’, ‘Re-sequencing’, ‘Exception’, ‘Order Assignment’, ‘Flexible Assignment’, ‘Centralization’, ‘Case Manager’, ‘Extra Resources, ‘Specialist-Generalist’, ‘Buffering’, ‘Task Automation’, ‘Integral Business Process Technology’, ‘Trusted Party’, and ‘Interfacing’.

Based on the above listed transformation patterns, some data points required to check the applicability of the identified transformation patterns are identified. Thereafter, transformation patterns are selected from the identified transformation patterns on the basis of their applicability, and non-applicable transformation patterns are eliminated.

Data points such as queue time, set-up time and process time, bank liability (in the case of fraud), and the like, assist in eliminating the non-applicable transformation patterns. Based on the analysis of the data points, such as applying the applicability algorithms, few transformation patterns are eliminated from the identified transformation patterns. For example, the transformation pattern ‘Task Composition’ is eliminated since the set-up time is less, as compared to the total process time. Further, the transformation pattern ‘Control Relocation’ is eliminated since it increases the possibility of fraud.

The selected transformation patterns are then analyzed by a consultant along with the business user(s) to verify the practical applicability of the selected transformation patterns, based on which the following 7 transformation patterns are finally selected: ‘Order-based Work’, ‘Triage’, ‘Re-sequencing’, ‘Centralization’, ‘Task Automation’, ‘Contact Reduction’, and ‘Integral Business Process Technology’. Based on the list of the selected transformation patterns, the practitioner or consultant applies these transformation patterns to optimize or redesign the business process.

FIG. 4 is a flowchart of a method for identifying transformation patterns corresponding to process characteristics in accordance with an aspect of the present disclosure. Each process characteristic has at least one corresponding transformation pattern which is identified at step 308 (FIG. 1). The transformation patterns are identified from the predefined set of transformation patterns stored in a transformation pattern database 236. The identification of the transformation patterns requires the predefined set of transformation patterns as an input. At step 402 in FIG. 4, a first process characteristic is selected from the process characteristics identified at step 106. Thereafter, all the transformation patterns in the predefined set of transformation patterns are selected (step 404).

At step 406, one or more transformation patterns are identified from the transformation patterns selected at step 404 on the basis of the impact of the transformation patterns on the selected process characteristic. For example, if process characteristic X needs to be increased and process characteristic X increases when transformation pattern P is applied, then transformation pattern P has a positive impact on process characteristic X. On the contrary, if process characteristic X decreases, this implies that transformation pattern P has a negative impact on process characteristic X.

At step 408, it is determined whether any other process characteristic needs to be selected or checked. All the process characteristics identified at step 306 are checked separately at step 408. If all the identified process characteristics have been selected or checked, the process proceeds to step 412.

However, if more than one process characteristic identified at step 306 needs to be selected, the process proceeds to step 410. At step 410, the next process characteristic is selected from the process characteristics identified at step 306, whereby the process returns to step 404 to allow selection of all the transformation patterns from the predefined set of transformation patterns.

For example, for process characteristic Y, 10 transformation patterns are identified from the predefined set of transformation patterns. Suppose 8 transformation patterns are common between the transformation patterns identified for process characteristic X as well as Y i.e. these 8 transformation patterns have a positive impact on both, process characteristic X and process characteristic Y. Therefore, the remaining 2 transformation patterns (10-8) are added to the original list of 15 identified transformation patterns and therefore, the number of the identified transformation patterns increases to 17. Similarly, steps 408 and 410 are repeated until no other process characteristic needs to be selected.

Regarding step 412, the system eliminates the transformation patterns on the basis of their impact on the constraints and the process characteristics selected at steps 402 and 410. At step 412, the transformation patterns that are identified as constraints are eliminated, whereby the process continues to Block C.

For example, when process characteristic Z is identified as a constraint, and if 2 of the 17 transformation patterns identified above have a negative impact on process characteristic Z, then the 2 transformation patterns are eliminated from the 17 identified transformation patterns. Also, if any of the 17 transformation patterns has a negative impact on either of the selected process characteristics, i.e., process characteristic X and process characteristic Y, the transformation pattern is eliminated from the 17 identified transformation patterns.

FIGS. 5A and 5B illustrate a flowchart of a method for selecting transformation patterns for optimizing the process characteristics in accordance with an aspect of the present disclosure. As stated above in regards to FIG. 3, the transformation patterns are selected to optimize the process characteristics which are identified (step 306).

Referring to FIG. 5A, a first transformation pattern is selected from the identified transformation patterns (step 502). Thereafter, data points are used to refer to the information corresponding to the business process in checking which transformation patterns are applicable (step 504). If it is determined that no other data points are required to check the applicability of the selected transformation pattern, the process moves to step 512 (discussed below).

On the other hand, it is determined whether the data points can be obtained (step 506). In an aspect, data points may be obtained from one or more user(s) via a user interface, and/or from applicable information stored in a database. If data points cannot be obtained, it is determined whether the data points can be estimated (e.g. extrapolation, interpolation, standard deviation) (step 508).

At step 510, data points are captured either by obtaining or estimating the data points. At step 512, one or more applicability or optimization algorithms are applied to the captured data points, whereby the applicability algorithms generate transformation possibilities to determine whether the transformation pattern, selected at step 502, can be applied in the business process or not.

At step 514, it is determined whether the selected transformation pattern satisfies one or more criteria associated with conditions mentioned in the applicability algorithms. For example, the applicability algorithm corresponding to the transformation pattern ‘Exception’ includes the following two criteria: ‘Standard Deviation=‘High’’ and ‘Number of cases where standard deviation is ‘High’>30%’. If the selected transformation pattern satisfies one or more criteria, the selected pattern is included in the list of the transformation patterns that are applicable to be applied in the business process.

At step 518, it is determined whether any other transformation pattern needs to be selected or checked. If no other identified transformation pattern needs to be checked, the list of the applicable transformation patterns generated at step 516 is displayed via a user interface.

If all the identified transformation patterns have not been selected, then the next identified transformation pattern is selected (step 520). Thereafter, the process returns to step 504, whereby the system determines whether any other data points are required to check the applicability of the selected transformation pattern. This process repeats until no other identified transformation pattern needs to be selected. Thereafter, the process continues to Block C.

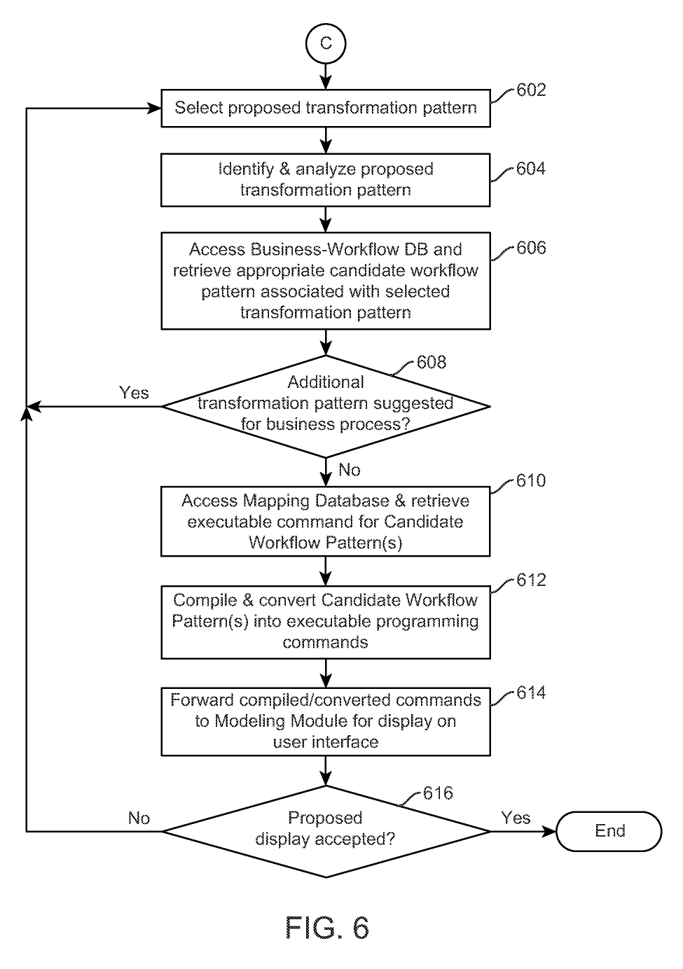

FIG. 6 illustrates a flowchart of the method of generating and displaying one or more proposed workflow patterns in accordance with an aspect of the present disclosure. As shown in FIG. 6, after the transformation patterns for a business process are selected, the design module 210 selects a proposed transformation pattern from the one or more generated transformation patterns (step 602). Thereafter, the design module 210 analyzes the proposed transformation pattern to determine which workflow patterns are applicable (step 604).

The workflow design module 228 then accesses the business-workflow database and retrieves the appropriate candidate workflow patterns that are associated with the selected transformation pattern (step 606). In step 608, it is determined whether additional transformation patterns are suggested for the business process. If so, the process repeats back to step 602. If not, the workflow mapping module 230 accesses the mapping database and retrieves one or more executable commands for each candidate workflow pattern that is generated by the workflow design module 228 (step 610).

The design module thereafter compiles and converts each candidate workflow pattern into executable programming commands (step 612). The design module 210 then forwards the compiled/converted commands to a modeling module for display on the user interface (step 614).

Thereafter, the displayed workflow pattern(s) associated with the selected transformation patterns of the business process are presented to the user, whereby the user can decide whether to accept or reject the displayed workflow pattern(s) (step 616). If the user rejects the displayed workflow pattern, the process returns to step 602. Otherwise, the process ends.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A method for optimizing one or more business processes in an organization, the method comprising:
selecting, using one or more processors, at least one business process to be optimized;
identifying, using one or more processors, a first performance indicator associated with the selected business process;
identifying, using one or more processors, a first process characteristics corresponding to at least the first performance indicator; and
determining, using one or more processors, at least one transformation pattern corresponding to the first process characteristics, wherein the at least one transformation pattern is identified based on at least one predefined criteria.

2. The method of claim 1, further comprising:
selecting a first transformation pattern for optimizing the one or more process characteristics;
analyzing the first transformation pattern and retrieve one or more workflow patterns associated with the first transformation pattern from a database;
mapping the one or more workflow patterns to a corresponding one or more executable programming commands; and
executing the programming commands to display the workflow patterns in a user interface.

3. The method of claim 1, further comprising identifying a point of applicability of the selected transformation patterns in the one or more business processes, wherein the selected transformation patterns are applied in the business process at a point of applicability.

4. The method of claim 1, further comprising identifying a first improvement opportunity associated with the business process.

5. The method of claim 4, wherein identifying the first one or more performance indicators and the first improvement opportunities comprises defining the one or more performance indicators of the business process, wherein the one or more performance indicators are defined by a user.

6. The method of claim 4, further comprising associating at least one of an improvement opportunity and a performance indicator with at least one process characteristic.

7. The method of claim 1, wherein the predefined set of process characteristics and the set of predefined transformation patterns are stored in a transformation pattern database.

8. The method of claim 7, wherein the at least one predefined criterion is based on impact of the at least one transformation pattern on the corresponding process characteristics wherein the at least one predefined criterion is and stored in the transformation pattern database.

9. The method of claim 1, further comprising analyzing, using one or more processors, a set of data points corresponding to the business process, wherein the set of data points is used for checking the applicability of the identified transformation patterns.

10. A non-transitory machine readable medium having stored thereon instructions for optimizing one or more business processes in an organization, comprising machine executable code which when executed by at least one machine, causes the machine to:
select at least one business process to be optimized;
identify a first performance indicator associated with the selected business process;
identify a first process characteristics corresponding to at least the first performance indicator; and
determine at least one transformation pattern corresponding to the first process characteristics, wherein the at least one transformation pattern is identified based on at least one predefined criteria.

11. The non-transitory machine readable medium of claim 10 further comprising:
select a first transformation pattern for optimizing the one or more process characteristics;
analyze the first transformation pattern and retrieve one or more workflow patterns associated with the first transformation pattern from a database;
map the one or more workflow patterns to a corresponding one or more executable programming commands; and
execute the programming commands to display the workflow patterns in a user interface.

12. The non-transitory machine readable medium of claim 10, further comprising identify a point of applicability of the selected transformation patterns in the one or more business processes, wherein the selected transformation patterns are applied in the business process at a point of applicability.

13. The non-transitory machine readable medium of claim 10, further comprising identify a first improvement opportunity associated with the business process.

14. The non-transitory machine readable medium of claim 13, wherein identifying the first one or more performance indicators and the first improvement opportunities comprises defining the one or more performance indicators of the business process, wherein the one or more performance indicators are defined by a user.

15. The non-transitory machine readable medium of claim 14 further comprising associate at least one of an improvement opportunity and a performance indicator with at least one process characteristic.

16. The non-transitory machine readable medium of claim 10, wherein the predefined set of process characteristics and the set of predefined transformation patterns are stored in a transformation pattern database.

17. The non-transitory machine readable medium of claim 16, wherein the at least one predefined criterion is based on impact of the at least one transformation pattern on the corresponding process characteristics wherein the at least one predefined criterion is and stored in the transformation pattern database.

18. The non-transitory machine readable medium of claim 10, further comprising analyze a set of data points corresponding to the business process, wherein the set of data points is used for checking the applicability of the identified transformation patterns.

19. A computer system comprising:
a network interface configured to allow communications between the computing system and one or more network devices;
a memory configured to implement code configured to optimize one or more business processes in an organization;
a processor coupled to the network interface and the memory, the processor operative to execute the code to:
select at least one business process to be optimized;
identify a first performance indicator associated with the selected business process;
identify a first process characteristics corresponding to at least the first performance indicator; and
determine at least one transformation pattern corresponding to the first process characteristics, wherein the at least one transformation pattern is identified based on at least one predefined criteria.

20. The computer system of claim 19, wherein the processor is configured to:
select a first transformation pattern for optimizing the one or more process characteristics;
analyze the first transformation pattern and retrieve one or more workflow patterns associated with the first transformation pattern from a database;
map the one or more workflow patterns to a corresponding one or more executable programming commands; and
execute the programming commands to display the workflow patterns in a user interface.

21. The computer system of claim 19, wherein the processor is configured to:
identify a point of applicability of the selected transformation patterns in the one or more business processes, wherein the selected transformation patterns are applied in the business process at a point of applicability.

22. The computer system of claim 19, wherein the processor is configured to:
identify a first improvement opportunity associated with the business process.

23. The computer system of claim 19, wherein the processor is configured to:
identifying the first one or more performance indicators and the first improvement opportunities comprises defining the one or more performance indicators of the business process, wherein the one or more performance indicators are defined by a user.

24. The computer system of claim 23, wherein the processor is configured to:
associate at least one of an improvement opportunity and a performance indicator with at least one process characteristic.

25. The computer system of claim 19, wherein the predefined set of process characteristics and the set of predefined transformation patterns are stored in a transformation pattern database.

26. The computer system of claim 19, wherein the at least one predefined criterion is based on impact of the at least one transformation pattern on the corresponding process characteristics wherein the at least one predefined criterion is and stored in the transformation pattern database.

27. The computer system of claim 19, wherein the processor is configured to:
analyze a set of data points corresponding to the business process, wherein the set of data points is used for checking the applicability of the identified transformation patterns.
